(19) United States
(12) Patent Application Publication
(10) Pub. No.: US 2002/0034953 A1
(43) Pub. Date: Mar. 21, 2002

(54) Methods and apparatus for locating portable electronic devices

(75) Inventor: Dean James Tricarico, Carlsbad, CA (US)

Correspondence Address: COATS & BENNETT, PLLC, P O BOX 5, RALEIGH, NC, 27602, US

(73) Assignee: Telefonaktiebolaget LM Ericsson

(21) Appl. No.: 09/767,322

(22) Filed: Jan. 22, 2001

Related U.S. Application Data
(60) Provisional application No. 60/233,544, filed on Sep. 19, 2000.

(51) Int. Cl. H04Q 7/20

(52) U.S. Cl. 455/456; 342/357.1; 342/450

(57) ABSTRACT

A mobile device in a wireless communication network is provided with a positioner configured to determine geographic position information related to the device. The mobile device is further provided with a transceiver assigned a unique mobile number by a wireless communication system in which the device operates, and which is communicatively coupled to the positioner. The transceiver is configured to receive position requests directed to the mobile number and to transmit the position information in response to the position requests. In one implementation, a transceiver within a particular device is activated when a call is placed through the wireless communication system to the mobile number associated with the device. The location transceiver is configured to obtain position information from the positioner, and to continuously transmit the position information to the network node, as soon as the location transceiver is activated. The network node is configured to route the position information to a location control center. At the location control center, a map of the area proximate the location of the device is generated, and the location of the device is identified on the map, based on the received position information. If the positioner is unable to determine the position information for the device when requested, the transceiver is configured to continuously transmit a tone in response to the position request.

### BACKGROUND OF THE INVENTION

1. Field of the Invention

The invention relates generally to locating a portable electronic device, where the device is lost or the position of the device is otherwise unknown.

2. Background

The number and variety of portable electronic devices is growing. For example, devices such as PDAs, laptop computers, palm computers, cellular phones, and portable MP3 players are very popular. As the popularity and capability of these devices grows, users of the devices are becoming more and more dependent on them. For example, a PDA may contain all of a user's business contact information. A laptop may contain important presentation material, or even important company secrets. Even an MP3 player that stores a user's favorite songs can represent an investment of the user's time and money. The user, or the user's company, may be inconvenienced or even compromised if such devices are lost or stolen. Typically, however, the user has little recourse in trying to recover the device.

For example, a laptop computer may contain valuable trade secrets. But if the laptop were to be stolen, the users only recourse is to report the theft to the police. The police have limited resources, however, and recovering a stolen laptop may not receive the attention that the user would like. The user could hire a private investigator to try and recover the device, and if the trade secrets are valuable enough, then the cost of such an option may be worthwhile. But in the case of a PDA or other portable electronic device, such an option is probably not worth the cost. This does not mean, however, that loss of such devices would not have a large impact on the user.

### SUMMARY OF THE INVENTION

In accordance with the present invention, a mobile device, which is any device capable of being transported between different geographic locations, in a wireless communication network is provided with a positioner configured to determine geographic position information related to the device. The mobile device is further provided with a transceiver assigned a unique mobile number by a wireless communication system in which the device operates, and which is communicatively coupled to the positioner. The transceiver is configured to receive position requests directed to the mobile number and to transmit the position information in response to the position requests.

In one implementation, a transceiver within a particular device is activated when a call is placed through the wireless communication system to the mobile number associated with the device. The location transceiver is configured to obtain position information from the positioner, and to continuously transmit the position information to the network node, as soon as the location transceiver is activated. The network node is configured to route the position information to a location control center. At the location control center, a map of the area proximate the location of the device is generated, and the location of the device is identified on the map, based on the received position information. If for some reason the positioner is unable to determine the position information for the device when requested, the transceiver may be configured to continuously transmit a tone in response to the position request.

Other aspects, advantages and novel features of the invention will become apparent from the following Detailed Description of Preferred Embodiments, when considered in conjunction with the accompanying drawings.

### BRIEF DESCRIPTION OF THE DRAWINGS

The drawings illustrate both the design and utility of preferred embodiments of the invention, wherein:

FIG. 1 is a simplified block diagram illustrating a device configured to include a positioner and a transceiver in accordance with one embodiment of the invention.

FIG. 2 is a simplified block diagram illustrating a wireless communication system configured in accordance with one embodiment of the invention and in which the device of FIG. 1 is configured to operate.

FIG. 3 is a simplified block diagram illustrating a paging system configured in accordance with one embodiment of the invention and in which the device of FIG. 1 is configured to operate.

FIG. 4 is a simplified block diagram illustrating further embodiments of the device in FIG. 1.

### DETAILED DESCRIPTION OF THE PREFERRED EMBODIMENTS

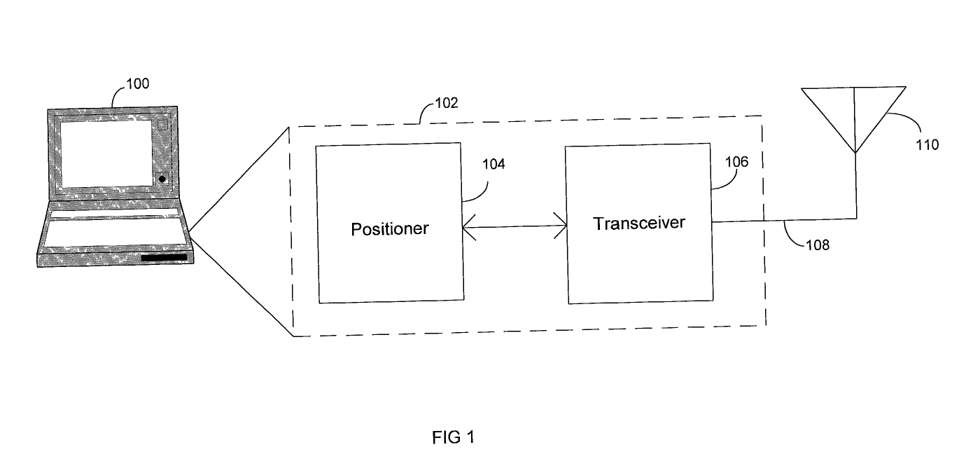

FIG. 1 illustrates a device 100, in this case a laptop computer, configured in accordance with one embodiment of the invention. Device 100 is typically a portable electronic device, but as will be apparent, device 100 is not limited to portable electronic devices. Device 100 includes a positioner 104 and a transceiver 106 that are configured to allow device 100 to be located when, for example, it is lost or stolen. In one embodiment, transceiver 104 and positioner 106 are combined in a single device 102, such as, for example, an integrated circuit that combines circuitry adapted to perform the functions of positioner 104 and transceiver 106. Positioner 104 is configured to acquire position information for device 100 and typically comprises a GPS receiver. Therefore, the position information will typically comprise the latitude and longitude coordinates of device 100.

A GPS receiver works by determining the position of at least three satellites in radio communication with the GPS receiver. The GPS comprises 24 satellites in all so that at least four of them are above the horizon for any given point on earth at any given time. To determine the satellite positions, a GPS receiver typically stores an almanac containing the positions of all 24 satellites. Once the GPS receiver has located the satellites, it uses the radio transmissions therefrom to determine the distance between the satellites and the GPS receiver by measuring the time it takes for the transmission to reach the receiver. Once the GPS receiver has this “transmission time” for each satellite, it can determine the distances to the satellites because radio transmissions travel at a known rate. Therefore, the transmission time multiplied by the known rate will provide the distance to a satellite. Combing the position and distance information for at least three satellites provides the latitude and longitude position of the receiver. If a fourth satellite is added, altitude can be determined as well.

Positioner 104 is capable of communicating the position information to transceiver 106. The position information may be communicated using standard protocols such as standard GPS communication protocols. Alternatively, if required, the position information can be communicated using a proprietary protocol developed for a specific implementation. Transceiver 106 includes a receiver, configured to receive position information requests, and a transmitter, configured to transmit the position information in response to such a request. In a typical embodiment, transceiver 106 is a radio transceiver. In which case, transceiver 106 will include an antenna port 108 coupled to an antenna 110. Antenna 110 is configured to receive radio signals containing position requests and couple them to the receiver portion of transceiver 106 through port 108. Antenna 110 is also configured to transmit radio signals containing the position information that are coupled from the transmitter portion of transceiver 106 to antenna 110 through port 108.

Ideally, positioner 104, transceiver 106, and antenna 110, if required, are physical small and therefore the constraints on where they are positioned within device 100 are minimal. In this case, a main concern will be adequate RF performance in terms of sensitivity and transmission power of the antenna-transceiver combination. RF performance will vary for different combinations of antenna 110, devices 100, and the position of antenna 110 within device 100. Therefore, the exact construction and position of antenna 110 within device 100 will be dependent on the requirement of each particular implementation.

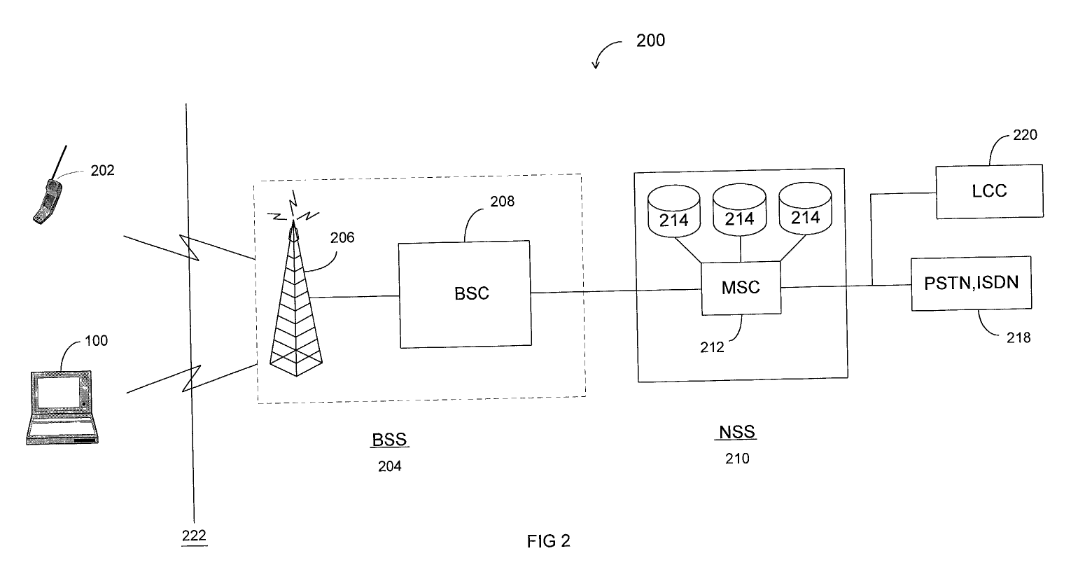

As will be seen, transceiver 106 is not limited to radio transceivers. Where transceiver 106 is a radio transceiver, however, a wireless communication system such as system 200 in FIG. 2 is used to locate device 100. Wireless communication system 200 includes a plurality of mobile devices 202, a Base Station Subsystem (BSS) 204, and a Network Switching Subsystem (NSS) 210. Mobile devices 202 are assigned a mobile number within system 200 and are generally configured to communicate voice and/or data over a wireless communication or air interface 222. BSS 204 interfaces with mobile devices 202 to manage radio transmission paths between mobile devices 202 and NSS 210. In turn, NSS 210 manages system switching functions with public networks 218 such as the PSTN or the ISDN.

BSS 204 is comprised of multiple Base Transceiver Stations (BTS) 206 and at least one Base Station Controller (BSC) 208. A BTS 206 is usually at the center of a “cell” and consists of one or more radio transceivers with an antenna. BTS 206 establishes radio links and handles radio communication over air interface 222 with mobile devices 202 within the “cell.” BSC 208 manages multiple BTSs 206 including the allocation and management of radio channels and the control and handover of communications between its transceivers.

Air interface 222 comprises a range of frequencies in the RF spectrum. This range is then divided into a plurality of channels. Typically, each mobile device 202 is assigned two channels that are separated by some fixed frequency. One channel, the forward channel, carries transmission from a BTS 206 to a mobile device 202. The second channel, the reverse channel, carries transmissions from a mobile device 202 to a BTS 206. Unless otherwise specified, the term radio channel as used in this specification refers to the forward and reverse channels in combination.

BSC 208 communicates with NSS 210. A Mobile Switching Center (MSC) 212 is the primary component of NSS 210. MSC 212 manages communications between mobile devices 202 and between mobile devices 202 and public network 218. In addition, MSC 212 typically interfaces with several databases 214 to manage communication and switching functions. For example, MSC 212 may interface with a Home Location Register (HLR) that contains details on each mobile device 202 residing within the area served by the mobile switching center. There may also be a Visitor Location Register (VLR) that temporarily stores data about roaming mobile devices 202 within a coverage area of a particular MSC 212. An Equipment Identity Register (EIR) that contains a list of mobile devices 202 may also be included. The EIR may also contain a list of equipment that has been lost or stolen allowing identification of attempts to use such equipment. There may also be an Authorization Center (AuC) that stores authentication and encryption data parameters that verify s mobile device user's identity.

To the extent that the following examples refer to wireless communication system 200, it is by way of example only, and is not intended to limit the use of the invention. Further, those skilled in the art will understand that there are many variations in wireless communication system architectures including variations in the communication protocols used for the various communication links within such systems. It will be apparent that the invention will work equally well with all possible architectures and all possible communication protocols. In fact, it is preferable that transceiver 106 be designed to implement multiple protocols so that a device 100 can operate in multiple systems without changing the transceiver. For example, in one embodiment, transceiver 106 is capable of implementing a combination of air interface 222 protocols such as GSM, TDMA, CDMA, and WCDM. Such a transceiver, therefore, is capable of operating in multiple variations of system 200.

In order for device 100 to work within a wireless communication system 200, device 100 must be assigned a mobile number just like a mobile device 202. In fact, a mobile device 202 can operate as a device 100, i.e., a mobile device 202 may include a positioner 104 and a transceiver 106. In this case, the mobile device 202 would have two mobile numbers; one for use in communicating voice and/or data and one for use in determining the location of the device. Therefore, there will be a plurality of mobile devices 202 and a plurality of devices 100 operating within system 200. In one embodiment, a new field in the HLR would keep track of which mobile numbers where assigned to devices 100 for location services.

If a device 100 is lost or stolen, then the owner of the device can activate transceiver 106 by placing a call to the mobile number associated with device 100. When the owner places the call, transceiver 106 is activated and receives the call, which contains a request for position information related to the device. The request may be in the form of information encoded in the call, or it may be implied, i.e., the fact that the call is being received indicates that position information is being requested. Once transceiver 106 receives the position request, it begins obtaining position information from positioner 104. The transceiver then transmits the position information, which is received by BSS 204 and routed to MSC 212.

The operator of system 200 may charge the user of a device 100 a flat rate for providing location services. Alternatively, or in addition to a flat rate, the operator may charge for the “airtime” used when locating device 100. Thus, the location service associated with devices 100 can generate significant revenue for operators of system 200. The impact on system capacity would be minimal, however, because devices 100 would only use air-time if they are lost or stolen.

Once the position information reaches MSC 212 it is routed to a Local Control Center (LCC) 220 that is configured to determine the location of device 100 from the position information. In FIG. 2, LLC 220 is shown directly coupled to MSC 212. In another embodiment, MSC 212 may be coupled to LCC 220 through public network 218. In still another embodiment, however, LCC 220 may be integrated into a Network Operating Center (NOC) associated with system 200. LCC 220 may even be integrated into NSS 210.

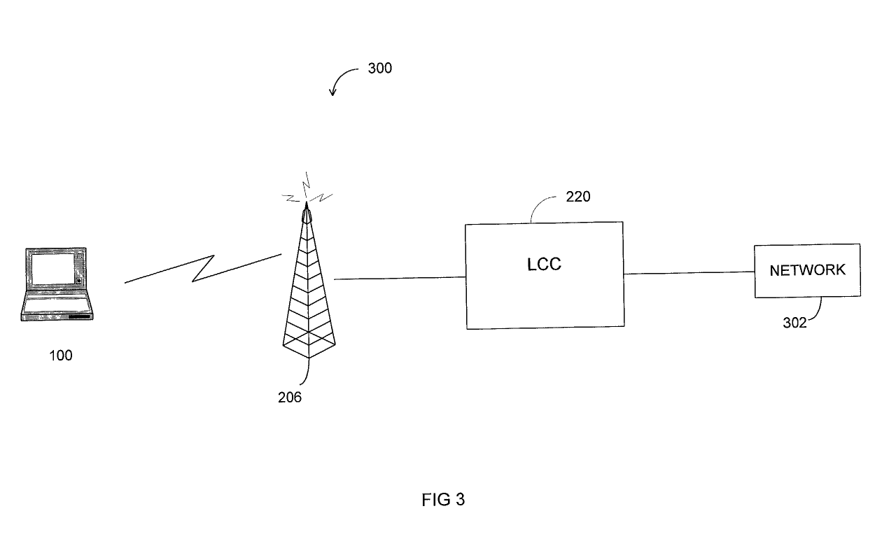

Alternatively, LCC 220 may not be incorporated into a wireless communication system such as system 200 at all. Instead LCC 220 may be part of a system dedicated solely to locating devices 100. Such a system may, for example, operate as a paging system. In this case, LCC 220 may be directly coupled to BTSs 206 as shown in FIG. 3. In this embodiment, LCC 220 is interfaced to a local telephone company through network interface 307. Network interface 302 can be a single line or several telephone line connections. For example, network interface 302 can comprise direct inward dial circuits, T1 circuits, or network connections.

As in the previous embodiments, a device 100 is assigned a number within system 300. When a device 100 is lost or stolen, the owner can activate a transceiver 106 within the device by placing a call to the number. The call is connected to LCC 220 through network interface 302. LCC 220 translates the call into paging information that is sent to BTSs 206. In turn, BTSs 206 broadcast the information to devices 100. The appropriate transceiver 106 will then respond to the page by transmitting position information back to LCC 220. As such, LCC 220 may be incorporated into a control point (not shown) of an existing paging network, or a customized paging network such as network 300 can be utilized.

Once the position information reaches the LCC, a map is constructed of the surrounding area and the particular device 100 is located within the map. Once the location and map have been acquired, this information can be communicated to a security service, the police, or some other third party, who can then recover the device. Optionally, the information can simply be forwarded to the device owner.

For example, when a laptop owner losses the laptop or has it stolen, he can immediately call the mobile number associated with the laptop. The call is then routed to the correct wireless communication system 200, which will verify through the HLR or VLR that the mobile number is used for location services. System 200 then communicates a position request to the laptop, which is received in a transceiver 106 within the laptop. The transceiver responds to the request with its current coordinates obtained from a positioner 104 within the laptop. The process is continuous throughout the call. In other words, as long as the call is active, transceiver 106 continues to obtain position information from positioner 104 and transmits it to system 200.

In the event that positioner 106 is unable to provide position information, transceiver 104 can, depending on the embodiment, transmit a continuous tone. For example, in a wireless communication system 200, transmitting a continuous tone allows location via triangulation using BTSs 206. For triangulation to be effective, the transmission from transceiver 106 must have some indication of the transmission timing; which will allow system 200 to determine how long it took the transmission to reach a particular BTS 206. Essentially, transceiver 106 will broadcast the continuous tone to all BTSs 206 within range. When the tone is received at a BTS 206, the timing information will allow a determination of how long it took the transmission to reach the BTS and therefore the distance between the device 100 and the BTS 206 can be determined. This distance will define the radius of a circle with the BTS at the center and on the perimeter of which the device 100 will be located. The intersection of three such circles, provides the location of the device.

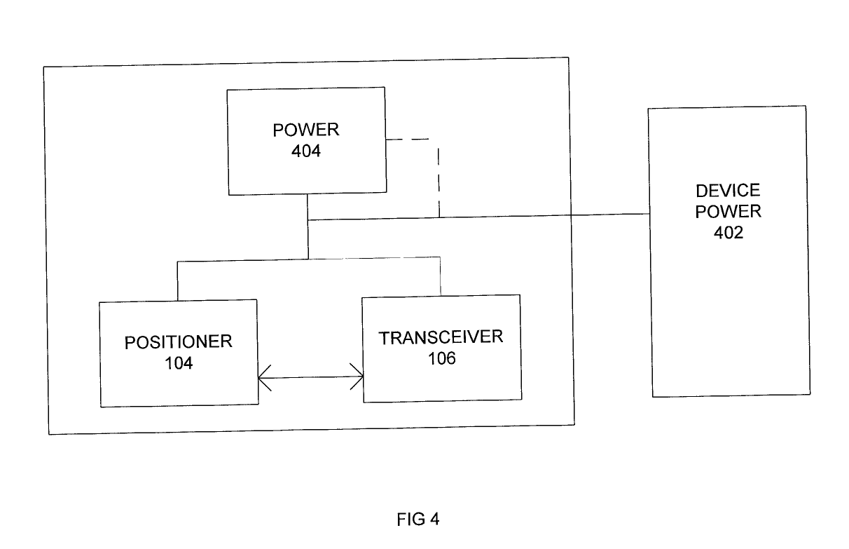

Inclusion of the location components, i.e., positioner 104 and transceiver 106, within a device 100 should have a minimal impact on device 100. In fact, the only real requirement is that the location components will need to draw a minimal amount of power while they are on standby and a slightly higher amount of power while they are operating. This, is illustrated in FIG. 4, where device power 402 is shown coupled to positioner 104 and transceiver 106. Device power 402 may not always be available, however. For example, if device power 402 is an AC or battery supply in a laptop computer, the location components will not be able to draw power if the device is unplugged, or if the battery charge is depleted. Therefore, in certain embodiments, an independent power source 404, such as a small battery is provided.

In one embodiment including source 404, device power 402 is coupled to the location components in parallel with power source 404. In this case device power 402 is the primary source when it is installed, and power source 404 takes over only when device power 402 is removed. In one particular embodiment of this kind, power source 404 contains switching circuitry and device power 402 is actually coupled to power source 404. Switching between the two supplies then takes place via the switching circuitry. In an alternative embodiment only power source 404 is coupled to the location components and the components do not draw any power from device power 402.

In order to minimize the impact of including the location components, in terms of cost and area, each component can be reduced to a single integrated circuit (IC), i.e., a positioner IC and a transceiver IC. Alternatively, the two components can be combined in a single location IC. In one embodiment, the single location IC also includes power source 404. Therefore, in laptops and other devices in which space is a valuable commodity, and which do not already include a communications transceiver, the invention can be reduced to a single IC for inclusion in the device. In devices that do include a communications transceiver, such as a PDA or cell phone, only the positioner IC need be included. The communications transceiver included in the device can then be used to interrogate the positioner IC in response to the position request.

It should be noted, that a location IC or individual transceiver and positioner IC can be optionally installed by including them on a removable media such as a SIM or PCMCIA card. Thus, for example, a PDA or cell phone may include a slot for installing a SIM card. To enable location determination, a SIM card that includes a location IC is installed in the slot.

Moreover, use of the invention is not limited to portable electronic devices. For example, a location IC can be installed within a car radio. Such a location IC would need to include its own power source 404, because once the car radio was removed from the car there would no longer be any device power 402. Similarly, a location IC can be installed in home electronics. In fact, if a power source 404 is included, a location IC or combination of a transceiver IC and a positioner IC can be included or installed in any product that can be lost or stolen, such as, for example, a car, a bicycle or a motorcycle.

Additionally, transceiver 106 is not limited to being a wireless transceiver. For example, transceiver 106 can be used to transmit and receive information over a computer network such as the Internet. In one embodiment of this type, transceiver 106 is activated when the device is connected to the network. Typically, LCC 220 is also directly connected to the network. Therefore, the position requests are generated and the position information is received directly by the LCC.

While embodiments and implementations of the invention have been shown and described, it should be apparent that many more embodiments and implementations are within the scope of the invention. Accordingly, the invention is not to be restricted, except in light of the claims and their equivalents.

What is claimed is:

1. A mobile device, comprising:
a positioner configured to determine geographic position information related to the device; and
a transceiver assigned a unique mobile number by a wireless communication system in which the device operates, and which is communicatively coupled to the positioner, the transceiver configured to receive position requests directed to the mobile number and to transmit the position information in response to the position requests.

2. The device of claim 1, wherein the positioner comprises a GPS receiver.

3. The device of claim 1, wherein the transceiver is configured to continuously transmit a tone in response to a received position request if the positioner is unable to determine the position information.

4. The device of claim 1, wherein the positioner and the transceiver are included on a removable card installed in the device.

5. The device of claim 1, wherein the transceiver is a wireless transceiver.

6. The device of claim 5, wherein the wireless transceiver is configured to transmit and receive information using at least one of the following communication protocols: CDMA, TDMA, GSM, and WCDMA.

7. The device of claim 1, further comprising a first power source and a second power source, wherein the first power source is configured to supply power to the device, and wherein the second power source is configured to continuously supply power to the positioner and to the transceiver.

8. The device of claim 1, further comprising a first power source and a second power source, wherein the first power source is configured to supply power to the device, including the positioner and the transceiver, and wherein the second power source is configured to supply power to the positioner and the transceiver whenever the first power source is unavailable.

9. The device of claim 1, wherein the positioner is a positioner IC and the transceiver is a transceiver IC.

10. The device of claim 1, wherein the positioner and transceiver are both incorporated in a location IC.

11. A wireless communication system comprising at least one network node and a plurality of wireless devices, the wireless communication system configured to associate a mobile number with each device, each device comprising:
a positioner configured to determine position information related to the device; and
a transceiver communicatively coupled to the positioner, the transceiver configured to receive position requests directed to the respective mobile number assigned to the particular device and to transmit the position information in response to the position requests.

12. The wireless communication system of claim 11, wherein a transceiver within a particular device is activated when a call is placed through the wireless communication system to the mobile number associated with the device, and wherein the location transceiver is configured to obtain position information from the positioner, and to continuously transmit the position information to the network node, as soon as the location transceiver is activated.

13. The wireless communication system of claim 12, wherein the network node is configured to route the position information to a location control center.

14. The wireless communication system of claim 13, wherein the location control center is configured to generate a map, and to locate a respective device on the map, based on received position information from the device.

15. The wireless communication system of claim 14, wherein the transceiver is configured to continuously transmit a tone in response to a position request if the positioner is unable to determine the position information.

16. A method of locating a mobile device in a wireless communication network, comprising:
associating an identification number with the device;
placing a call to the identification number, when the location of the device is needed;
receiving position information from the device in response to the call; and
establishing the location of the device based on the position information.

17. The method of claim 16, wherein placing the call to the device causes a location transceiver in the device to become active and to perform steps comprising:
receiving the call to the identification number associated with the device;
obtaining the respective position information from a positioner in the device; and
transmitting the position information.

18. The method of claim 16, wherein locating the device further comprises:
routing the position information to a location control center;
generating a map of the area proximate the location of the device; and
locating the device within the map.
